(19) United States
(12) Patent Application Publication
(10) Pub. No.: US 2017/0282366 A1
(43) Pub. Date: Oct. 5, 2017

(54) Device, System And Method For Setting An Operation Of A Robot Unit, And Use Of A Device

(71) Applicant: ABB Schweiz AG, Baden (CH)

(72) Inventors: Magnus Wahlström, Västerås (SE); Daniel Lindqvist, Västerås (SE)

(21) Appl. No.: 15/507,653

(22) PCT Filed: Aug. 28, 2014
(86) PCT No.: PCT/EP2014/068255

§ 371 Date: Feb. 28, 2017

(51) Int. Cl. B25J 9/16; G05B 19/042

(52) U.S. Cl. CPC B25J 9/1656; G05B 19/0426; G05B 2219/23039; G05B 2219/23051; G05B 2219/32126

(57) ABSTRACT

A device for setting an operation of a robot unit where the device is adapted to create or modify a robot control program that is executed by a robot controller that controls the operation of the robot unit. The device includes a Central Processing Unit (CPU) adapted to execute a software program for creating or modifying the robot control program, wherein a user platform is adapted to be connected to the device for enabling input of information to the software program. The device has a platform independent Representational State Transfer communication protocol (REST client) and means for transferring a platform independent REST client to the user platform, which platform independent REST client enables the user platform to communicate with the software program.

### FIELD OF THE INVENTION

The present invention relates to a device for setting an operation of a robot unit. The device is adapted to create or modify a robot control program that is executed by a robot controller that controls the operation of the robot unit. In particular, the device is adapted to be used for controlling the robot controller. The device comprises a Central Processing Unit (CPU) adapted to execute a software program for creating or modifying said robot control program, wherein a user platform is adapted to be connected to the device for enabling input of information to the software program. The present invention also relates to a system comprising the device, a method for setting the operation of a robot unit by means of the device, and use of the device.

### BACKGROUND

In prior art devices and systems for controlling one or more robots units, a software program is used in particular for modifying a robot control program that is executed by a robot controller. The software program assists the operator in programming the functions of the robot unit, such as setting the movement paths or the adjusting the positions of the robot unit. The software program can be installed and used on a regular personal computer. An example of such software program is “PickMaster” developed and marketed by ABB AB.

A problem with such devices is that it is difficult to connect all the different available user platforms to the device for communications with the software program. The user platforms are for example mobile phones, tablet devices, etcetera. Presently, in order to communicate with the software program, it is necessary for the operator to create a REST client that is specifically arranged for the user platform that is to be connected to the device. Taking into account the amount of different available user platforms, it is nearly impossible to provide REST clients to all user platforms that are available to be used in communication with the software program. Furthermore, new user platforms are continuously being released to the market. Accordingly, prior art devices for setting the operation of a robot unit have the disadvantage that it is impractical and time consuming to connect different user platforms to the devices.

### SUMMARY

An object of the present invention is to provide a device that facilitates the connection and use of different user platforms together with the software program of the device. A further object of the invention is to provide a device that enables different user platforms to communicate with the software program without the use of an internet connection.

This object is obtained by the different features of the present teachings. The device is characterized in that the device comprises a platform independent REST client and means for transferring the platform independent REST client to the user platform, which platform independent REST client enables the user platform to communicate with the software program.

By transferring and installing the platform independent REST client to the user platform, a connection between the device and the different user platform is enabled. Thereby, different user platform can easily be connected and used for input of information to the software program. The user platforms are for example various types of mobile phones, tablet devices, etcetera.

The means for transferring the platform independent REST client is for example an established internet connection between the user platform and the location where the platform independent REST client is being stored. The term “REST client” refers to a Representational State Transfer communication protocol.

According to an embodiment of the invention, the device comprises a cloud platform that stores the platform independent REST client and which cloud platform is adapted to allow the platform independent REST client to be transferred to the user platform.

By arranging the platform independent REST client on a cloud platform, the platform independent REST client is made available for the user to download in a simple manner. Furthermore, it is possible to assure that the available platform independent REST client on the cloud platform is the latest version for optimal communication with the software program.

The term “cloud platform” is to be interpreted as a platform available for the user platform to connect to by means of an internet connection. The cloud platform may for example be a web server.

According to an embodiment of the invention, the device is adapted to allow the platform independent REST client to be replaced with an updated version that is adapted to be transferred to the user platform.

By enabling the platform independent REST client to be updated on the user platform, it is assured that the available platform independent REST client is the latest version for optimal communication with the software program.

According to an embodiment of the invention, the platform independent REST client comprises a REST API protocol for communication between the user platform and the software program.

According to an embodiment of the invention, the platform independent REST client comprises a web application. The web application is used for presenting information from the software program and for input of information to the software program.

According to an embodiment of the invention, the web application is a HTML5 application.

The HTML5 application enables connection and communication between the device and the user platform without a functioning internet connection. Accordingly, the use of the user platform with the device is, after the platform independent REST client has been transferred and installed on the user platform, independent of an internet connection.

According to an embodiment of the invention, the web application is adapted to be executed on a web browser on the user platform.

The invention also relates to a system comprising a robot unit, a robot controller and a device. Furthermore, the invention relates to use of a device for setting the operation of a robot unit.

The invention furthermore relates to a method for setting the operation of a robot unit by means of a device, wherein the method comprises:
transferring the platform independent REST client to the user platform,
installing the platform independent REST client on the user platform, and
establishing communication between the user platform and the software program by means of the platform independent REST client.

According to an embodiment of the invention, the method comprises:
establishing communication directly between the user platform and the software program without the use of an internet connection.

According to an embodiment of the invention, the method comprises:
establishing communication directly between the user platform and the software program using HTML5 and Javascript.

According to an embodiment of the invention, the method comprises:
executing the web application on the user platform for enabling input of information to the software program.

According to an embodiment of the invention, the method comprises:
arranging the platform independent REST client on a cloud platform, and
transferring the platform independent REST client from the cloud platform to the user platform.

According to an embodiment of the invention, the method comprises:
replacing the platform independent REST client with an updated version,
transferring the updated platform independent REST client to the user platform,
installing the updated platform independent REST client on the user platform, and
establishing communication with the software program by means of the updated platform independent REST client.

### BRIEF DESCRIPTION OF THE DRAWINGS

The invention will now be explained more closely by the description of different embodiments of the invention and with reference to the appended figures.

FIG. 1 shows a system comprising a robot unit, a robot controller and a device according to an embodiment of the invention.

FIG. 2 shows a flowchart of a method for setting the operation of a robot unit according to a first embodiment of the invention.

FIG. 3 shows a flowchart of a method for setting the operation of a robot unit according to a second embodiment of the invention.

### DETAILED DESCRIPTION

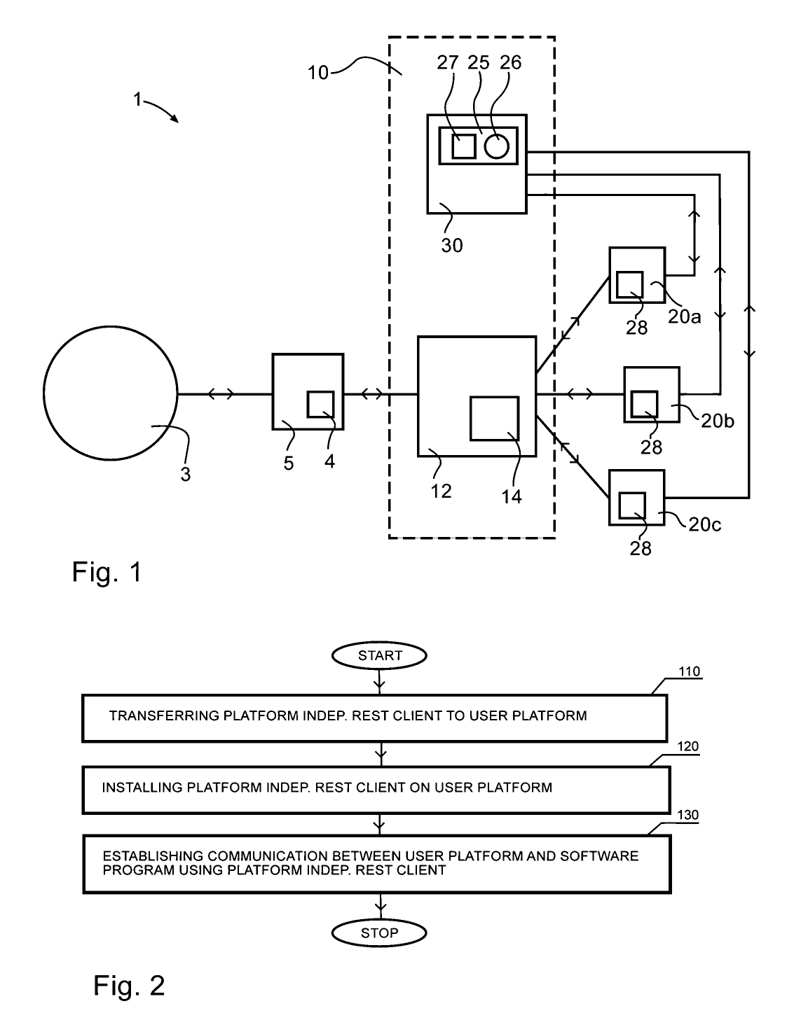

FIG. 1 shows a system 1 comprising a robot unit 3, a robot controller 5 and a device 10 according to an embodiment of the invention. The device 10 is arranged for setting the operation of the robot unit 3.

The device 10 is adapted to create or modify a robot control program 4 that is executed by the robot controller 5. In the disclosed example the device 10 comprises a computer unit comprising a CPU 12 that is adapted to execute a software program 14 that helps the user to create or modify a robot control program 4 that is used by the robot controller 5 for controlling the operation of the robot unit 3. After a robot control program 4 has been created by the software program 14, the robot control program 4 is transferred to the robot controller 5 that executes the robot control program 4.

The software program 14 is mainly used for modifying and correcting the robot control program 4. In particular, the software program 14 is used to control the operation of the robot unit 3 in runtime, such as adjusting the position to which the robot unit 3 is to be arranged. Accordingly, the software program 14 is used for controlling the robot controller 5.

Different user platforms, such as mobile phones, tablet devices, etcetera, are adapted to be connected to the CPU 12 in order to input information to the software program 14 for creating or modifying the robot control program 4. In the disclosed embodiment, three different user platforms 20a-c are connected to the CPU 12.

The device 10 further comprises means for transferring a platform independent REST client 25 to the user platforms 20a-c that are adapted to install the platform independent REST client 25. After being installed, the platform independent REST client 25 enables the user platforms 20a-c to communicate with the software program 14. By means of the platform independent REST client 25 different user platforms can easily be connected and used for input of information to the software program 14.

Preferably, the platform independent REST client 25 comprises a REST API protocol 26 that is used for the communication between the user platforms 20a-c and the software program 14.

According to an embodiment of the invention, the platform independent REST client 25 comprises a web application 27 that is used in the communication between the user platforms 20a-c and the software program 14. The web application 27 is executed with a web browser 28 on the user platform 20a-c.

The web application 27 is preferably a HTML5 application, wherein HTML5 and JavaScript are used in the communication with the software program 14. This has the advantage that the communication between the user platforms 20a-c and the software program 14 is independent on an available internet connection. Thus, once the platform independent REST client 25 has been transferred and installed on the user platform 20a-c, the user platform 20a-c can be connected and used for creating and modifying robot control programs 4 with the software program 14.

In the disclosed embodiment, the means for transferring a platform independent REST client 25 comprise a cloud platform 30 that stores platform independent REST client 25. The cloud platform 30 is accessible by means of an internet connection and allows the platform independent REST client 25 to be downloaded to the user platforms 20a-c.

The cloud platform 30 further enables the platform independent REST client 25 to be replaced by an updated version, which updated platform independent REST client 25 is adapted to be transferred and installed on the user platforms 20a-c. The updated version of the platform independent REST client 25 improves the communication between the user platforms 20a-c and the software program 14.

FIG. 2 shows a flowchart of a method for setting the operation of a robot unit 3 according to a first embodiment of the invention.

In a step 110, the method is initiated by transferring the platform independent REST client 25 from the cloud platform 30 to the user platform 20a-c. The transfer requires an established internet connection between the user platform 20a-c and the cloud platform 30.

Once the platform independent REST client 25 has been received by the user platform 20a-c, the method comprises, in a step 120, installing the platform independent REST client 25 on the user platform 20a-c.

After that the platform independent REST client 25 has been installed, the method comprises, in a step 130, establishing communication between the user platform 20a-c and the software program 14 by means of the platform independent REST client 25. Thereby, information can be transferred between the software program 14 and the user platform 20a-c. The user platform can be used for input of information to the software program 14 for creating or modifying the robot control program 4.

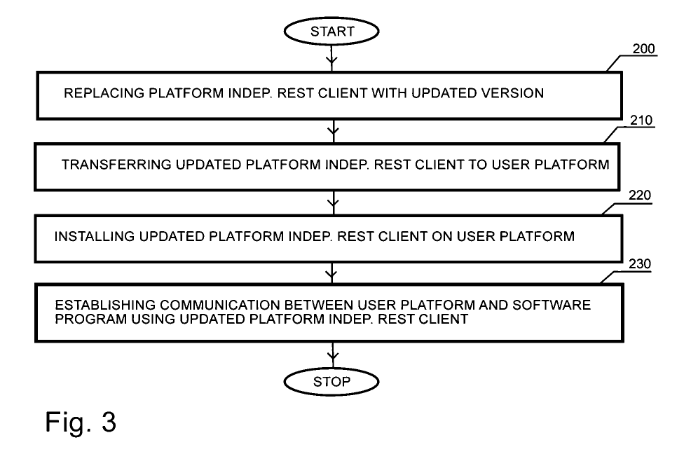

FIG. 3 shows a flowchart of a method for setting the operation of a robot unit 3 according to a second embodiment of the invention.

The method is initiated in a step 200 by replacing the platform independent REST client 25 on the cloud platform 30 with an updated version. The updated version of the platform independent REST client 25 is arranged to improve the communication between the software program 14 and the user platform 20a-c. The replacement requires an established internet connection to connect to the cloud platform 30.

After that the platform independent REST client 25 has been replaced, the method comprises, in a step 210, transferring the updated platform independent REST client 25 from the cloud platform 30 to the user platform 20a-c. The transfer requires an established internet connection between the user platform 20a-c and the cloud platform 30.

Once the updated platform independent REST client 25 has been received by the user platform 20a-c, the method comprises, in a step 220, installing the updated platform independent REST client 25 on the user platform 20a-c.

After that the updated platform independent REST client 25 has been installed, the method comprises, in a step 230, establishing communication between the user platform 20a-c and the software program 14 by means of the updated platform independent REST client 25.

The present invention is not limited to the disclosed embodiments but may be modified within the framework of the claims.

1. A device for setting an operation of a robot unit, the device is adapted to create or modify a robot control program that is executed by a robot controller that controls the operation of the robot unit, the device comprises a Central Processing Unit (CPU) adapted to execute a software program for creating or modifying said robot control program, wherein a user platform is adapted to be connected to the device for enabling input of information to the software program, wherein the device comprises a platform independent Representational State Transfer communication protocol (REST client) and transfer the platform independent REST client to the user platform, which platform independent REST client enables the user platform to communicate with the software program.

2. The device according to claim 1, wherein the device comprises a cloud platform that stores the platform independent REST client, and which cloud platform is adapted to allow the platform independent REST client to be transferred to the user platform.

3. The device according to claim 1, wherein the device is adapted to allow the platform independent REST client to be replaced with an updated version that is adapted to be transferred to the user platform.

4. The device according to claim 1, wherein the platform independent REST client comprises a REST API protocol for communication between the user platform and the software program.

5. The device according to claim 1, wherein the platform independent REST client comprises a web application.

6. The device (10) according to claim 5, wherein the web application is a HTML5 application.

7. The device according to claim 5, wherein the web application is adapted to be executed on a web browser on the user platform.

8. A system comprising a robot unit, a robot controller and a device for setting an operation of the robot unit, the device is adapted to create or modify a robot control program that is executed by the robot controller that controls the operation of the robot unit, the device comprises a Central Processing Unit (CPU) adapted to execute a software program for creating or modifying said robot control program, wherein a user platform is adapted to be connected to the device for enabling input of information to the software program, and wherein the device comprises a platform independent Representational State Transfer communication protocol (REST client) and transfer the platform independent REST client to the user platform, which platform independent REST client enables the user platform to communicate with the software program.

9. A method for setting the operation of a robot unit by means of a device for setting an operation of the robot unit, the device is adapted to create or modify a robot control program that is executed by a robot controller that controls the operation of the robot unit, the device comprises a Central Processing Unit (CPU) adapted to execute a software program for creating or modifying said robot control program, wherein a user platform is adapted to be connected to the device for enabling input of information to the software program, wherein the device comprises a platform independent Representational State Transfer communication protocol (REST client) and transfer the platform independent REST client to the user platform, which platform independent REST client enables the user platform to communicate with the software program, and wherein the method comprises:
transferring the platform independent REST client to the user platform,
installing the platform independent REST client on the user platform, and
establishing communication between the user platform and the software program with the platform independent REST client.

10. The method according to claim 9, wherein the method comprises:
establishing communication directly between the user platform and the software program without the use of an internet connection.

11. The method according to claim 10, wherein the method comprises:
establishing communication directly between the user platform and the software program using HTML5 and Javascript.

12. The method according to claim 9, wherein the method comprises:
executing the web application on the user platform for enabling input of information to the software program.

13. The method according to claim 9, wherein the method comprises:
arranging the platform independent REST client on a cloud platform, and
transferring the platform independent REST client from the cloud platform to the user platform.

14. The method according to claim 9, wherein the method comprises:
replacing the platform independent REST client with an updated version,
transferring the updated platform independent REST client to the user platform,
installing the updated platform independent REST client on the user platform, and
establishing communication with the software program with the updated platform independent REST client.

15. Use of a device for setting the operation of a robot unit, said device is adapted to create or modify a robot control program that is executed by the robot controller that controls the operation of the robot unit, the device comprises a Central Processing Unit (CPU) adapted to execute a software program for creating or modifying said robot control program, wherein a user platform is adapted to be connected to the device for enabling input of information to the software program, wherein the device comprises a platform independent Representational State Transfer communication protocol (REST client) and transfers the platform independent REST client to the user platform, which platform independent REST client enables the user platform to communicate with the software program.

16. The device according to claim 2, wherein the device is adapted to allow the platform independent REST client to be replaced with an updated version that is adapted to be transferred to the user platform.

17. The device according to claim 6, wherein the web application is adapted to be executed on a web browser on the user platform.
